(19) United States
(12) Patent Application Publication
(10) Pub. No.: US 2024/0110079 A1
(43) Pub. Date: Apr. 4, 2024

(54) TWO-COMPONENT PAINT SYSTEM

(71) Applicant: PETER KWASNY GMBH, Gundelsheim (DE)

(72) Inventors: Hans-Peter KWASNY, Heilbronn (DE); Wolfgang Lothar KRANIG, Bad Friedrichshall (DE)

(73) Assignee: PETER KWASNY GMBH, Gundelsheim (DE)

(21) Appl. No.: 18/285,284

(22) PCT Filed: Mar. 31, 2022
(86) PCT No.: PCT/EP2022/058539

§ 371 Date: Oct. 2, 2023

(30) Foreign Application Priority Data
Mar. 31, 2021 (DE) 10 2021 108 237.4

(51) Int. Cl. C09D 175/04; B65D 83/68; C08G 18/24; C08G 18/32; C08G 18/76; C08G 18/80

(52) U.S. Cl. CPC C09D 175/04; B65D 83/687; C08G 18/246; C08G 18/3206; C08G 18/7671; C08G 18/8016

(57) ABSTRACT

Two-component paint system comprising a binding agent component and a curing agent component which are separated from one another prior to application of the paint system and are brought into contact with one another for application, so that the binding agent in the binder component crosslinks by contact with the curing agent component, with the binder component containing, in addition to the binding agent, at least one solvent which is unreactive with the curing agent component, a crosslinking catalyst and a propellant agent, characterized in that the curing agent component is obtainable by pre-reaction of a deficient amount of a bi- or trifunctional low-molecular-weight active hydrogen-carrying compound with an isocyanate-based crosslinker having a residual content of monomeric or dimeric isocyanates of ≤1% w/w, said paint system being contained in a 2K aerosol spray can provided with an inner casing.

The invention relates to a 2-component paint system consisting of a binding agent component and a curing agent component, which are separated from one another prior to application of the paint system and brought into contact with one another for application, so that the binding agent in the binder component crosslinks by contact with the curing agent component, the binder component containing, in addition to the binding agent, at least one solvent which is unreactive with the curing agent component, a crosslinking catalyst and a propellant agent. The 2-component paint system is contained in a conventional 2K aerosol spray can provided with an inner casing.

Two-component paint systems are well known and widely used for the coating of surfaces. A preferred field of application is the automotive repair sector. Paint systems of this nature are as a rule applied in the form of aerosols. Also used in this context are aerosol cans having an inner casing that can be actuated from the outside, the binding agent component being contained in the aerosol can, the curing agent component in the inner casing. Actuation of the inner casing results in the curing agent/hardener component to exit and mix into the binder component causing it to crosslink.

Curing agent/hardener components commonly used in the coatings industry are those based on polyfunctional isocyanates. Such polyfunctional isocyanates are mostly mixtures and usually contain highly volatile and toxic monomeric and dimeric constituents that can ingress into the user's respiratory tract in the form of fine droplets when exiting an aerosol spray can. The content of such respirable constituents in aerosol formulations is therefore limited by legislation. However, compliance with the respective thresholds often proves problematic.

2K pressurized cans for the application of paint systems and insulating foams are also known. Such pressurized cans contain an externally actuated inner casing for the curing agent/hardener component, which is activated only just before the pressurized can is put to use. Exemplary reference is made in this respect to the pressurized cans described in publications WO 85/00 157 A1, WO 2002/076 852 A1, WO2004/056 660, 2008/092 670 A1 or DE 10 2005 049 400 A1.

Accordingly, the objective of the present invention is to provide a 2-component paint system having a limited content of low-molecular-weight isocyanate group-bearing dyes.

This is achieved with a 2-component paint system of the kind first mentioned above, in which the curing agent component is obtainable by pre-reaction of a deficient amount of a bi- or trifunctional low-molecular-weight active hydrogen-carrying compound with an isocyanate-based crosslinker having a residual content of monomeric or dimeric isocyanates of 1% w/w.

Expediently, the residual content of monomeric or dimeric isocyanates amounts to no more than 0.5% w/w and is 0.1% w/w.

To bring about crosslinking of the binding agent of the binder component the employed isocyanates are polyfunctional, that is, they contain at least two isocyanate groups. Due to production necessities, these isocyanates are mixtures of monomers, dimers and higher condensed isocyanates. As an example, reference is made to the frequently used raw MDI. Analogously, the same applies to other aromatic and aliphatic polyfunctional isocyanates. The low-molecular constituents, in particular the monomers, are considered problematic.

It has proven very practical to lower the monomer content of such polyfunctional isocyanates by reacting them with nanofunctional alcohols. Alcohols predominantly react with the low molecular constituents of such mixtures, that is, with the monomers. Using a deficient amount of alcohols, an adequate number of isocyanate groups remains in the mixture to achieve a subsequent reaction, such as crosslinking.

This low level of toxic isocyanates is achieved by pre-reaction with a bi- or trifunctional low-molecular-weight active hydrogen-bearing compound. Low molecular weight alcohols or amines, such as diols, triols, diamines or triamines, are preferred. Especially preferred are ethylene glycol and ethylenediamine.

The compounds should not have more than six carbon atoms.

Therefore, the pre-reaction is aimed at chemically binding the hardener components that are particularly critical to health and converting them into oligomeric or polymeric chemical products, so that they are less critical.

After pre-reaction, the curing agent component enters into a crosslinking reaction with the binder component in the 2K aerosol can and in this way is bound to the binder component and reacts to form polymeric structures. This ensures that respirable toxic particles are no longer discharged when 2K aerosol cans are actuated.

In particular, aromatic and aliphatic polyisocyanates can be employed as crosslinkers, for example those put on the market by BASF under the tradename of Basonate.

It is particularly preferred to carry out the pre-reaction for producing the curing agent component in the inner casing of 2K aerosol cans. For this purpose, the components, the isocyanate component and the compound containing active hydrogen, are as a rule filled into the inner casing together with an inert solvent and allowed to react there. The reaction usually takes place in a period ranging between 5 minutes and 8 hours, in particular is completed within 15 minutes and 2 hours. Usually an inert solvent is added, for example acetone or butyl acetate. Immediately after the components have been filled in, the inner casing can be sealed. By taking this approach, the need to have the pre-reaction performed in a separate reactor is avoided. Nevertheless, such an optional procedure may of course also be followed, in which case the pre-reacted curing agent component is introduced into the inner casing.

In addition to the binding agent itself, the binder component also contains a catalyst that promotes crosslinking, an unreactive solvent and a propellant gas. Catalysts for the crosslinking of isocyanates are well known, and an example is dibutyltin dilaurate, which is a trimerization catalyst. Other common catalysts can also be used, but it must be borne in mind that the type of catalyst will affect the waiting time that must elapse before spraying of the paint system can start. Ketones, in particular acetone and butyl acetate, can be mentioned as unreactive or inert solvents. Suitable propellants include, for example, hydrocarbons that can be liquefied under pressure, such as propane or butane, dimethyl ether or mixtures thereof. Dimethyl ether, which also serves as solvent for the binding agent component, is particularly suitable.

The binding agent of the binder component contains conventional paint system additives and, if necessary, pigments. In this context, these include defoamers, fillers, wetting aids, stabilizers, corrosion inhibitors, film-forming aids and matting agents, which means that both clear paint coatings and pigmented coatings can be produced.

As a guideline for the weight ratios, it can be stated that the binding agent component and the curing agent component are present in a weight ratio of between 5:1 and 15:1, in particular about 10:1. In the curing agent component, the active hydrogen-bearing compound and the isocyanate-based crosslinker are present in particular in a weight ratio of between 1:20 and 1:100, depending on the proportion of toxic constituent in the crosslinker.

In order to improve the mixing of the binding agent component with the curing agent component after the inner casing has been actuated, the aerosol can may contain a mixing aid in the form of a ball or a small rod made of metal.

The invention is explained in more detail by way of the following example.

A preferred paint system has the following composition:

The composition of the binding agent component is as follows:

| | | |
|---|---|---|
| 103 | g | Binding agent MIPA PU 240-90 2K-PU lacquer, |
| | | glossy RAL 3000 |
| 66.14 | g | Acetone |
| 11.7 | g | Butyl acetate |
| 0.3 | g | Dibutyltin dilaurate |
| 121 | g | Dimethyl ether |

The binding agent component is filled into a 2K aerosol can.

For the curing agent component, the following constituents are filled into the inner casing of the aerosol cans in the sequence specified below:

| | | |
|---|---|---|
| 0.3 | g | Ethylene glycol |
| 6.0 | g | Butyl acetate |
| 23.7 | g | Basonat HI 190 B/S NG |

The inner casing is then inserted into the 2K aerosol can and the can is sealed.

To apply the contents (paint), the can is actuated by destroying the casing located inside, shaken for 2 minutes to ensure the components are homogeneously distributed and then left to rest for 30 minutes. The paint can be sprayed after shaking the can again for 15 seconds. The paint spray contains less than 0.1% w/w of monomeric or dimeric isocyanates. The blending process is promoted by means of a mixing aid.

Due to the system being encapsulated in the 2K aerosol can, the user has no direct contact with the toxic constituents of the hardener component, since these have already been largely eliminated by mixing the components in the in casing and further reduced by reaction with the binding agent component. In the applied paint coat, the hardener component is bonded to the polymeric binding agent and thus has a polymeric character itself.

Application from the aerosol can is based on expelling and atomization of the paint system by means of propellant gas. The atomization process takes place immediately after the paint exits the nozzle of the aerosol cans, with the paint being directed in a targeted manner towards the object to be coated. Using dimethyl ether as a propellant results in the blowback of spray material in the direction of the user and, in this way, the user is exposed to a significantly lower dose of expelled paint constituents and potentially harmful low-molecular curing agent components.

The invention also relates to the method of filling such 2K aerosol cans as described in the example.

1. Two-component paint system comprising a binding agent component and a curing agent component which are separated from one another prior to application of the paint system and are brought into contact with one another for application, so that the binding agent in the binder component crosslinks by contact with the curing agent component, with the binder component containing, in addition to the binding agent, at least one solvent which is unreactive with the curing agent component, a crosslinking catalyst and a propellant agent, characterized in that the curing agent component is obtainable by pre-reaction of a deficient amount of a bi- or trifunctional low-molecular-weight active hydrogen-carrying compound with an isocyanate-based crosslinker having a residual content of monomeric or dimeric isocyanates of ≤1% w/w, said paint system being contained in a 2K aerosol spray can provided with an inner casing.

2. Two-component coating system according to claim 1, characterized in that the residual content of monomeric or dimeric isocyanates amounts to ≤0.1% w/w.

3. Two-component paint system according to claim 1, characterized in that the binding agent contains conventional additives and pigments.

4. Two-component paint system according to claim 1, characterized in that the binding agent component contains acetone and/or butyl acetate as solvent.

5. Two-component paint system according to claim 1, characterized in that the binding agent contains dibutyltin dilaurate as catalyst.

6. Two-component paint system according to claim 1, characterized in that the binding agent component contains dimethyl ether as propellant.

7. Two-component paint system according to claim 1, characterized in that the curing agent component contains a low-molecular-weight alcohol or a low-molecular-weight amine as active hydrogen-carrying compound.

8. Two-component paint system according to claim 7, characterized in that the active hydrogen-carrying compound is a diol, triol, diamine or triamine.

9. Two-component paint system according to claim 7, characterized in that the active hydrogen-carrying compound is ethylene glycol.

10. Two-component paint system according to claim 1, characterized in that the isocyanate-based crosslinker is an aliphatic polyisocyanate.

11. Two-component paint system according to claim 1, characterized in that the curing agent component is obtainable by pre-reaction in the inner casing of 2K aerosol cans.

12. Two-component paint system according to claim 11, characterized in that the curing agent component contains an inert solvent, in particular acetone or butyl acetate.
